(19) United States
(12) Patent Application Publication
(10) Pub. No.: US 2010/0000163 A1
(43) Pub. Date: Jan. 7, 2010

(54) Raised floor structure

(76) Inventors: Hong-I Tsai, Taipei City (TW); Yann-Shuoh Sun, Xindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/453,799

(22) Filed: May 22, 2009

(30) Foreign Application Priority Data
Jul. 1, 2008 (TW) 97124772

(51) Int. Cl. E04B 5/02; B65D 19/38; F16M 5/00

(52) U.S. Cl. 52/126.6; 108/57.12; 248/638

(57) ABSTRACT

A raised floor structure includes a vibration-damping platform and a support structure. The vibration-damping platform includes a bottom plate having a supporting face; a top plate located at a predetermined height position above the bottom plate to thereby define a vibration-buffering space therebetween; and a damping pad disposed in the vibration-buffering space between the top plate and the bottom plate. The support structure includes a plurality of supporting members connected to the supporting face of the bottom plate and located between the supporting face of the bottom plate and a foundation structure for supporting the vibration-damping platform thereon. Meanwhile, a raised space is formed between the bottom plate of the vibration-damping platform and the foundation structure.

### FIELD OF THE INVENTION

The present invention relates to a platform structure for supporting apparatuses and machines thereon, and more particularly to a raised floor structure.

### BACKGROUND OF THE INVENTION

Conventional materials or structures for a load-bearing platform generally include granite, honeycomb table, and reinforced concrete structure. The granite platform can provide very good structure stability, but it is relatively heavy. The honeycomb table is light in weight compared to the granite platform, but it has relatively complicated structure to cause difficulties in manufacturing and assembling thereof. Currently, the honeycomb table is applied only to optical tables that have high value. The platform with reinforced concrete structure has weight ranged between the granite platform and the honeycomb table, but has dynamic characteristics inferior than that of the granite platform and the honeycomb table.

In most plant houses involving semiconductor or photoelectric manufacturing process, reinforced concrete structure with grid iron is usually used with a raised floor constructed thereabove. The raised floor is one type of load-bearing platform structure. However, the raised floor generally does not have vibration isolating ability and is mainly used to provide a space below the floor for setting pipelines of various apparatuses and machines, so that operators working on the raised floor and the pipelines extending below the raised floor do not mutually interfere with one another. The space below the raised floor also enables ventilation of clean return air in a clean room. However, vibration produced by the movement of operators and transporting equipment would often be amplified by and transmitted via the raised floor structure to the plant house structure and every corner in the plant house. Such vibration will adversely affect the reliability of the high precision manufacturing process and high precision inspection instruments in the plant house.

That is, the raised floor structure in the early stage was designed without taking the elimination of vibration and noise into consideration. However, in the nowadays photoelectric industrial field, the transport equipment or robot for moving the large-size panels often produces large vibration, which is transmitted via the raised floor supporting the equipment to the surrounding environment in the plant house to adversely affect the high precision manufacturing process and high precision inspection equipment in the same environment, such as exposure machine, coating machine, and panel defect detector. Generally, the honeycomb structure for optical table not only involves complicated vibration-isolating design to cause difficulties in fabricating, assembling and disassembling components thereof, but also requires considerably large space to set up the honeycomb table. Therefore, it is uneasy and troublesome to maintain the honeycomb-structured optical table.

### SUMMARY OF THE INVENTION

A primary object of the present invention is to provide a raised floor structure that provides high damping effectiveness to eliminate vibration transmitted from surrounding environment and vibration produced by apparatuses and machines supported on the raised floor structure.

To fulfill the above objects, the present invention provides a raised floor structure including a vibration-damping platform and a support structure. The vibration-damping platform includes a bottom plate having a supporting face; a top plate located at a predetermined height position above the bottom plate to thereby define a vibration-buffering space therebetween; and a damping pad disposed in the vibration-buffering space between the top plate and the bottom plate. The support structure includes a plurality of supporting members connected to supporting face of the bottom plate and located between the supporting face of the bottom plate and a foundation structure for supporting the vibration-damping platform thereon. Meanwhile, a raised space is formed between the bottom plate of the vibration-damping platform and the foundation structure.

With the technical means adopted by the present invention, the raised floor structure can have a vibration-suppressing ability satisfying the vibration standard set for high precision equipment supported on the raised floor structure, and vibration within a predetermined bandwidth will not be amplified or extended. Therefore, the failure rate of apparatuses and machines on the raised floor structure can be effectively reduced to thereby increase the good yield of products.

Compared to the general honeycomb structure for optical table, the present invention includes members and elements having very simple geometrical shapes without causing difficulties in manufacturing the raised floor structure. Further, with uniform geometrical shapes, the members and elements of the present invention can be normalized and mass-produced to reduce the manufacturing cost thereof. Moreover, the members and elements, such as the damping pad, can be conveniently replaced, and the materials and shapes therefor can also be changed according to different requirements for vibration damping. Since the members and elements of the raised floor structure of the present invention are simplified and modularized, they can be easily disassembled from one another to reduce an overall volume of the raised floor structure to facilitate easy transport thereof, and can also be easily assembled again to enable quick installation of the vibration-damping platform while minimizing possible interference or contamination by surrounding environment.

For small-size precision equipment in laboratories, the vibration-damping platform provided by the present invention can be used separately. In this case, the top plate thereof can be properly increased in weight and provided with internally threaded holes, so as to be used in general laboratories as a desktop vibration-isolating base for precision instruments, such as an atomic force microscope required in optical measurement system or micro-nano inspection technology. And, the present invention can also be used as the vibration-damping raised floor structure required in semiconductor plants.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an assembled perspective view of a raised floor structure according to a first embodiment of the present invention;

FIG. 2 is an exploded view of FIG. 1;

FIG. 3 is a cross-sectional view taken along line 3-3 of FIG. 1;

FIG. 4 is an exploded sectional view of a supporting member for the raised floor structure of the present invention;

FIG. 5 is an enlarged side view of the circled area A of FIG. 1;

FIG. 6 is a schematic view of a raised floor structure according to a second embodiment of the present invention; and

FIG. 7 is a perspective view of a vibration-damping platform according to the present invention when used separately.

### DETAILED DESCRIPTION OF THE PREFERRED EMBODIMENTS

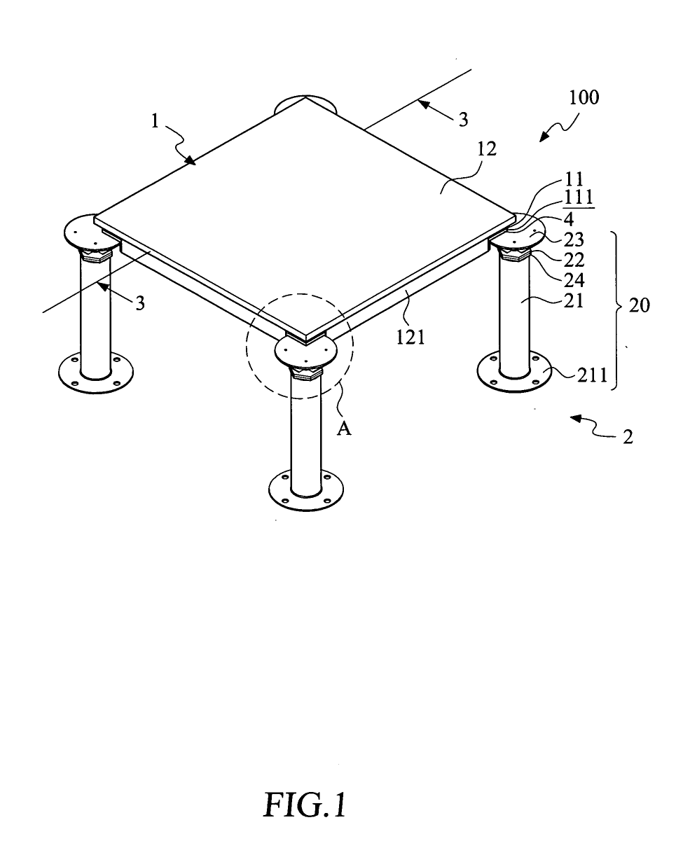

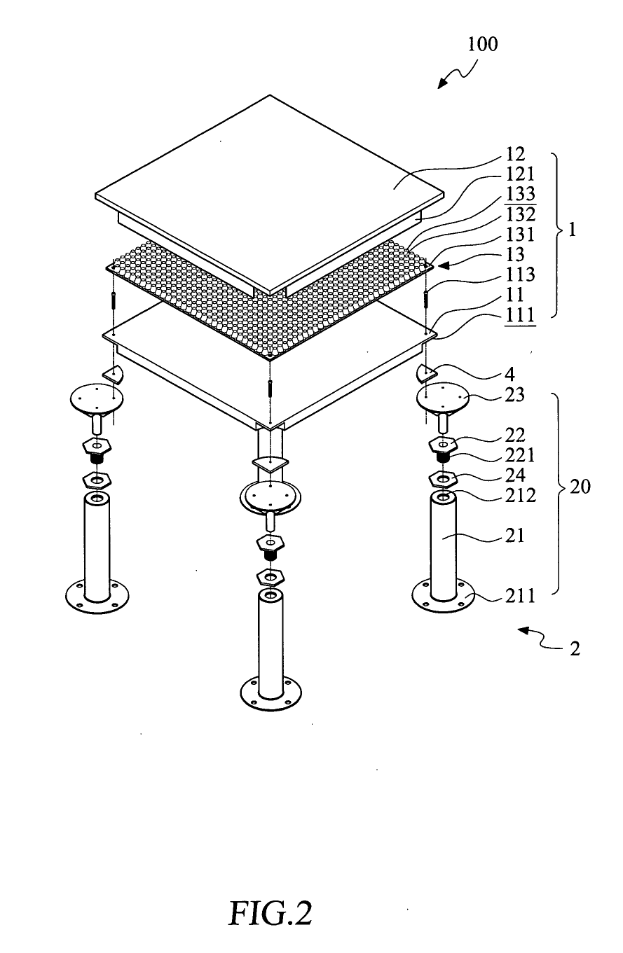

Please refer to FIGS. 1 and 2 that are assembled and exploded perspective views, respectively, of a raised floor structure 100 according to a first embodiment of the present invention. As shown, the raised floor structure 100 includes a vibration-damping platform 1 and a support structure 2. The vibration-damping platform 1 is a sandwich structure consisting of a bottom plate 11, a top plate 12, and a damping pad 13. The support structure 2 includes four supporting members 20 separately connected to a support face 111 of the bottom plate 11 of the vibration-damping platform 1, so as to support the vibration-damping platform 1 thereon.

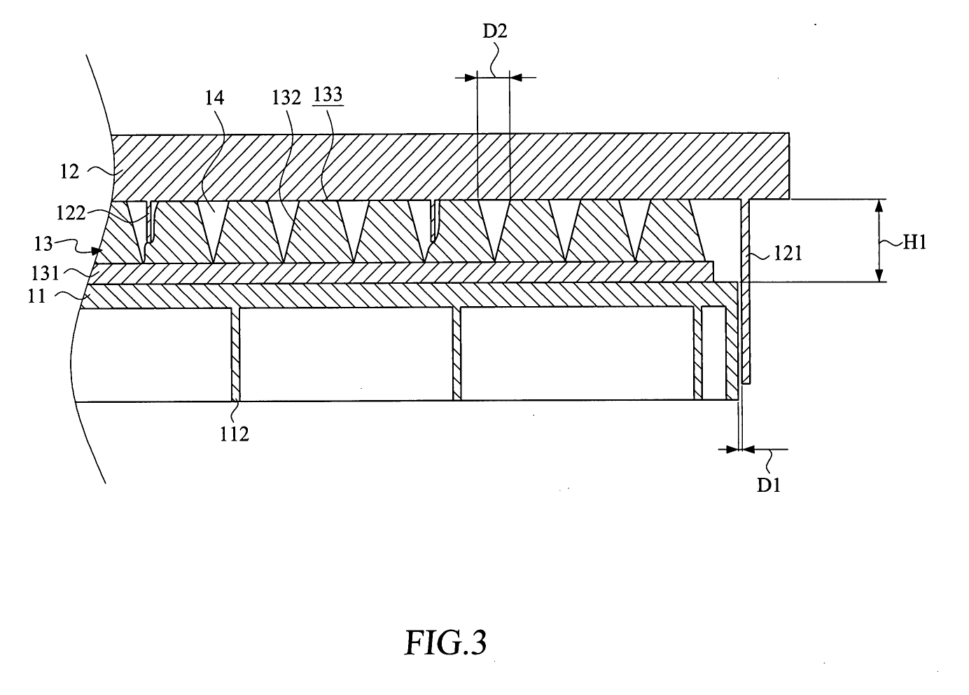

FIG. 3 is a cross-sectional view taken along line 3-3 of FIG. 1. Please refer to FIG. 3. The bottom plate 11 is provided on an underside with a plurality of ribs 112, each of which is downward extended from the underside of the bottom plate 11 by a predetermined distance. The ribs 112 are provided to give the bottom plate 11 an increased rigidity.

The top plate 12 is located at a height H1 above the bottom plate 11, so as to define a vibration-buffering space 14 between the top plate 12 and the bottom plate 11. The damping pad 13 is provided in the vibration-buffering space 14. The top plate 12 is provided with a plurality of side boards 121, which are downward extended from four sides of the top plate 12 by a predetermined distance, and are spaced from the bottom plate 11 and the damping pad 13 by a distance D1. When the bottom plate 11, the top plate 12 and the damping pad 13 are assembled together, the damping pad 13 and the bottom plate 11 are enclosed in the side boards 121 of the top plate 12, so that displacement and dislocation of these three components relative to one another can be avoided.

The top plate 12 also includes a plurality of ribs 122, which are downward extended from an underside of the top plate 12 by a predetermined distance, so that the top plate 12 can have an increased rigidity to avoid distortion or deformation under heavy load.

In the illustrated embodiment of the present invention, the damping pad 13 is made of a 1-butene polymeric material. However, it is understood the damping pad 13 can also be made of an ethylene polymeric material, a mixture of 1-butene polymeric material and ethylene polymeric material, or other functionally equivalent damping materials. The damping pad 13 includes a padding layer 131 and a plurality of vibration-damping columns 132 formed on and upward extended from the padding layer 131. The vibration-damping columns 132 are arrayed side by side with a space D2 formed between any two adjacent columns 132. Each of the vibration-damping columns 132 has a bearing face 133 for contacting with and supporting the top plate 12 thereon. In the illustrated first embodiment, the columns 132 are configured as truncated cones for providing vibration-isolating effect in both vertical and horizontal directions. However, the vibration-damping columns 132 can be configured into other shapes to meet the requirement for vibration isolation in other directions.

When there is vibration produced on the vibration-damping platform 1, since the bottom plate 11, the top plate 12 and the damping pad 13 are not fixedly locked to one another when they are assembled together, and since the top plate 12 is indirectly connected to the bottom plate 11 via the damping pad 13 instead of being directly connected to the bottom plate 11, the damping pad 13 functions to isolate the transmission of the vibration between the top plate 12 and the bottom plate 11. Through the buffering effect of the vibration-buffering space 14 and the damping effect of the damping pad 13, the vibration-damping platform 1 can suppress and absorb vibration transmitted thereto.

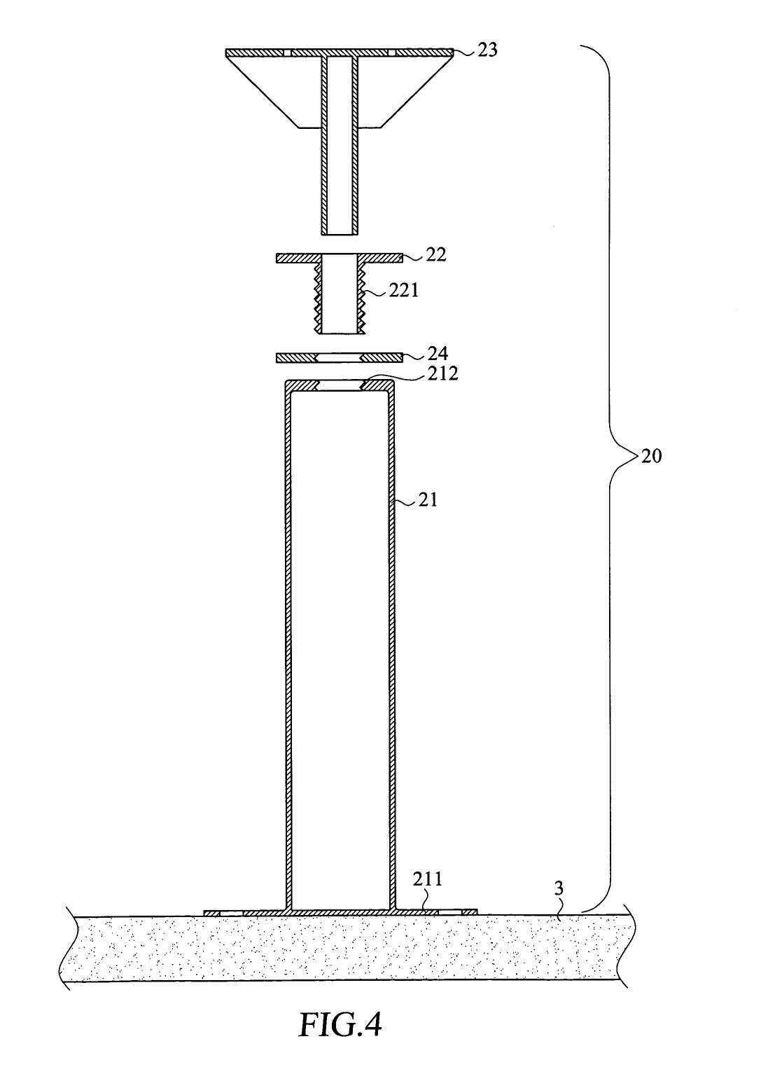

Please refer to FIG. 4 that is an exploded sectional view of the supporting member 20. As shown, each of the supporting members 20 includes a supporting pipe 21, a level adjusting element 22, a supporting disc 23, and a reinforcing element 24.

The supporting pipe 21 has a mounting base 211 and a fitting opening 212. Via the mounting base 211, the supporting member 20 is fixedly mounted on a foundation structure 3. The level adjusting element 22 has a fitting rod 221 for fitting in the fitting opening 212 on the supporting pipe 21. The supporting disc 23 is located atop the level adjusting element 22 for supporting the vibration-damping platform 1 thereon. The reinforcing element 24 is fitted around the fitting rod 221 of the level adjusting element 22 to reinforce the binding strength between the supporting pipe 21 and the level adjusting element 22.

In the illustrated first embodiment, the fitting opening 212 on the supporting pipe 21 is an internally threaded screw hole and the fitting rod 221 of the level adjusting element 22 is a screw rod, so that the supporting pipe 21 and the level adjusting element 22 are connected to each other through engagement of the screw hole with the screw rod. Therefore, by turning the fitting rods 221 relative to the fitting openings 212, the vibration-damping platform 1 can be finely adjusted to a desired height position in a fully horizontal plane above the foundation structure 3. The reinforcing element 24 is a locking nut. After the vibration-damping platform 1 has been adjusted to the desired height position, the reinforcing element 24 is turned along the fitting rod 221 to tightly abut on a top of the supporting pipe 21, so as to ensure firm and stable connection of the level adjusting element 22 to the supporting pipe 21.

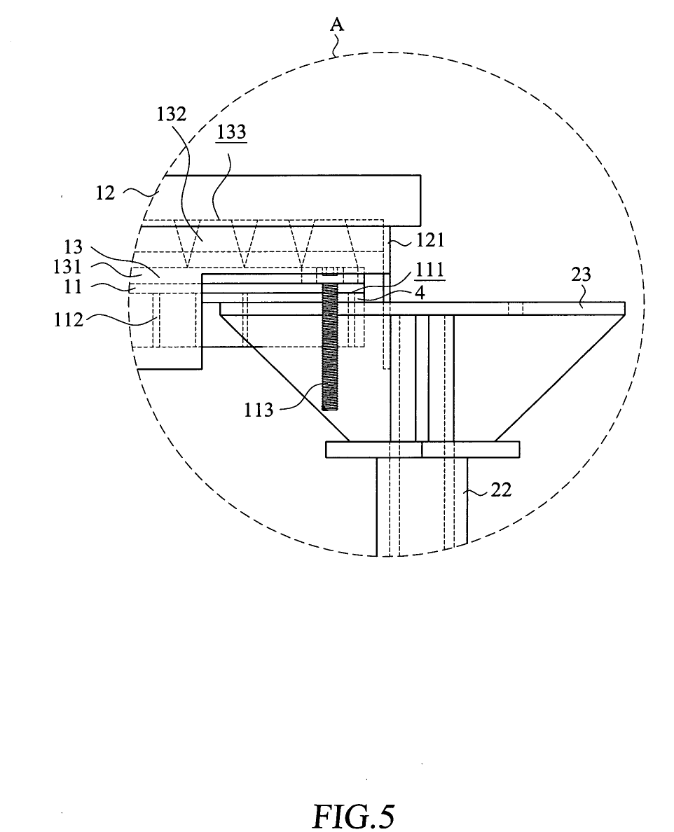

Please refer to FIG. 5 that is an enlarged side view of the circled area A in FIG. 1. As shown, the support face 111 of the bottom plate 11 is provided with a locating structure 113. In the illustrated first embodiment, the locating structure 113 includes a plurality of bolts for tightening the bottom plate 11 to the support structure 2. A vibration-isolating rubber pad 4 is provided between the support face 111 and each of the support members 20 to enhance the vibration-isolating effect between the platform 1 and the support structure 2, so that vibration produced by the platform 1 is not transmitted via the support structure 2 to cause any adverse influence.

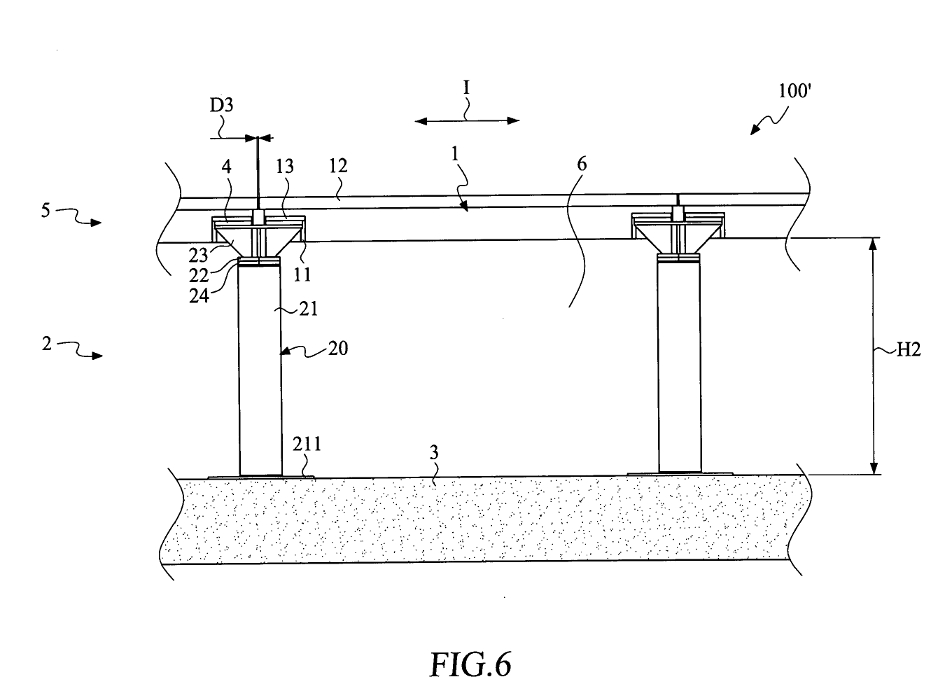

FIG. 6 is a schematic view of a raised floor structure 100′ according to a second embodiment of the present invention. Since the second embodiment is generally structurally similar to the first embodiment, elements that are same in the two embodiments are denoted by the same reference numerals. The second embodiment is different from the first embodiment in that the raised floor structure 100′ includes a plurality of vibration-damping platforms 1 and a support structure 2. The vibration-damping platforms 1 are arranged side by side with a space D3 left between any two adjacent platforms 1, so as to form an expanded platform 5 extended in a horizontal direction “I”. By providing the space D3 between any two adjacent platforms 1, vibration would not transmit from platform to platform. That is, vibration is isolated without being transmitted or even amplified on the expanded platform 5.

The support structure 2 supports the plurality of platforms 1 thereon, such that a predetermined height H2 is kept between the foundation structure 3 and the supporting faces 111 of the bottom plates 11 of the platforms 1 to thereby define a raised space 6 therebetween. The raised space 6 is intended to be used as an area for movement of operators, so that operators would not interfere with apparatuses or pipelines on the expanded platform 5.

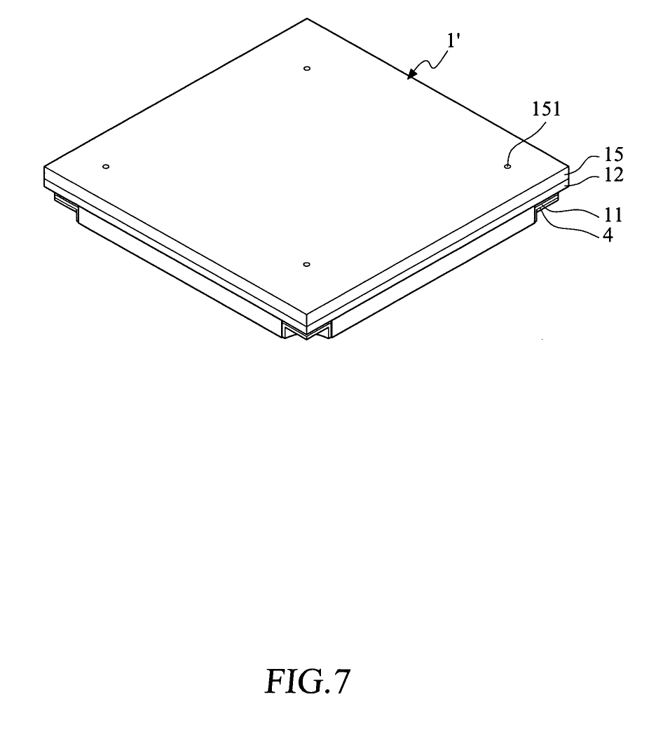

FIG. 7 is a perspective view of a vibration-damping platform 1′ according to the present invention when used separately. As shown, the vibration-damping platform 1′ is generally structurally similar to the above-described vibration-damping platforms 1. Therefore, elements that are same in the platforms 1 and 1′ will be denoted by the same reference numerals. The platform 1′ is different from the platform 1 in that it is directly disposed on the foundation structure 3 and further includes a weighted plate 15 disposed on the top plate 12. A plurality of internally threaded holes 151 is formed on the weighted plate 15 for mounting machines and apparatuses to the platform 1′ via the threaded holes 151.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. A raised floor structure, comprising:
a vibration-damping platform, which includes:
a bottom plate, having a supporting face;
a top plate, being located at a predetermined height position above the bottom plate, so that a vibration-buffering space is defined therebetween; and
a damping pad being disposed in the vibration-buffering space between the bottom plate and the top plate; and
a support structure, including a plurality of supporting members connected to the supporting face of the bottom plate of the vibration-damping platform and located between the supporting face of the bottom plate of the vibration-damping platform and a foundation structure for supporting the vibration-damping platform thereon, such that a raised space is formed between the supporting face of the bottom plate and the foundation structure.

2. The raised floor structure as claimed in claim 1, wherein the bottom plate is provided on an underside with at least one rib, and the rib is downward extended from the underside of the bottom plate by a predetermined distance.

3. The raised floor structure as claimed in claim 1, wherein the damping pad is made of a material selected from a group consisting of 1-butene polymeric material, ethylene polymeric material, and a combination of 1-butene polymeric material and ethylene polymeric material.

4. The raised floor structure as claimed in claim 1, wherein the damping pad comprises:
a padding layer; and
a plurality of vibration-damping columns formed on the padding layer, the vibration-damping columns being arranged with a space formed between any two adjacent columns, each vibration-damping column having a bearing face for supporting the top plate.

5. The raised floor structure as claimed in claim 1, wherein the support face of the bottom plate is provided with a locating structure for tightening the bottom plate of the vibration-damping platform to the support structure.

6. The raised floor structure as claimed in claim 1, wherein a vibration-isolating rubber pad is provided between the support face of the bottom plate and the support structure.

7. The raised floor structure as claimed in claim 1, wherein the supporting member comprises:
a supporting pipe, having a mounting base at one end and a fitting opening at the other end, in which via the mounting base, the supporting member is mounted on the foundation structure; and
a level adjusting element, having a fitting rod at a bottom for adjustably fitting at a predetermined height position in the fitting opening on the supporting pipe.

8. The raised floor structure as claimed in claim 7, wherein the supporting member further comprises a supporting disc which is located atop the level adjusting element for supporting the vibration-damping platform.

9. A raised floor structure, comprising:
a plurality of vibration-damping platforms, the vibration-damping platforms being arranged side by side with a space between any two adjacent platforms, so as to form an expanded platform extended in a horizontal direction, each vibration-damping platform comprising:
a bottom plate, having a supporting face;
a top plate, being located at a predetermined height position above the bottom plate, so that a vibration-buffering space is defined therebetween; and
a damping pad, being disposed in the vibration-buffering space between the bottom plate and the top plate; and
a support structure, including a plurality of supporting members connected to the supporting face of the bottom plate of the vibration-damping platform and located between the supporting face of the bottom plate of the vibration-damping platform and a foundation structure for supporting the vibration-damping platform thereon, such that a raised space is formed between the supporting face of the bottom plate and the foundation structure.

10. The raised floor structure as claimed in claim 9, wherein the bottom plate is provided on an underside with at least one rib, and the rib is downward extended from the underside of the bottom plate by a predetermined distance.

11. The raised floor structure as claimed in claim 9, wherein the damping pad is made of a material selected from a group consisting of 1-butene polymeric material, ethylene polymeric material, and a combination of 1-butene polymeric material and ethylene polymeric material.

12. The raised floor structure as claimed in claim 9, wherein the damping pad comprises:
a padding layer; and
a plurality of vibration-damping columns formed on the padding layer, the vibration-damping columns being arranged with a space formed between any two adjacent columns, each vibration-damping column having a bearing face for supporting the top plate.

13. The raised floor structure as claimed in claim 9, wherein the support face of the bottom plate is provided with a locating structure for tightening the bottom plate of the vibration-damping platform to the support structure.

14. The raised floor structure as claimed in claim 9, wherein a vibration-isolating rubber pad is provided between the support face of the bottom plate and the support structure.

15. The raised floor structure as claimed in claim 9, wherein the supporting member comprises:
a supporting pipe, has a mounting base at one end and a fitting opening at the other end, in which via the mounting base, the supporting member is mounted on the foundation structure; and
a level adjusting element, having a fitting rod at a bottom for adjustably fitting at a predetermined height position in the fitting opening on the supporting pipe.

16. The raised floor structure as claimed in claim 9, wherein the supporting member further comprises a supporting disc which is located atop the level adjusting element for supporting the vibration-damping platform.

17. A vibration-damping platform, which includes:
a bottom plate, disposed on a foundation structure;
a top plate, being located at a predetermined height position above the bottom plate, so that a vibration-buffering space is defined therebetween; and
a damping pad, being disposed in the vibration-buffering space between the bottom plate and the top plate.

18. The vibration-damping platform as claimed in claim 17, wherein the vibration-damping platform further comprises a weighted plate disposed on the top plate for supporting machines and apparatuses.

19. The vibration-damping platform as claimed in claim 17, wherein the damping pad is made of a material selected from a group consisting of 1-butene polymeric material, ethylene polymeric material, and a combination of 1-butene polymeric material and ethylene polymeric material.

20. The vibration-damping platform as claimed in claim 17, wherein the damping pad comprises:
a padding layer; and
a plurality of vibration-damping columns formed on the padding layer, the vibration-damping columns being arranged with a space formed between any two adjacent columns, each vibration-damping column having a bearing face for supporting the top plate.
